(19) United States
(12) Patent Application Publication
(10) Pub. No.: US 2026/0293933 A1
(43) Pub. Date: Oct. 1, 2026

(54) SEITAN FOOD PRODUCTS

(71) Applicant: Cargill, Incorporated, Wayzata, MN (US)

(72) Inventor: Fang Lan Lie, Edegem (BE)

(73) Assignee: Cargill, Incorporated, Wayzata, MN (US)

(21) Appl. No.: 19/475,811

(22) PCT Filed: Apr. 19, 2024
(86) PCT No.: PCT/US2024/025330

§ 371 Date: Oct. 16, 2025

(30) Foreign Application Priority Data
Apr. 20, 2023 (EP) 23168907.6

(51) Int. Cl. A23J 3/22; A21D 2/26; A23J 3/18; A23L 27/00; A23L 29/212; A23P 20/10

(52) U.S. Cl. CPC A23J 3/227; A21D 2/265; A23J 3/18; A23L 27/00; A23L 29/212; A23P 20/10

(57) ABSTRACT

The present disclosure relates to a seitan dry blend that comprises wheat protein, pea protein (preferably pea protein isolate), and vegetable bouillon. The present disclosure also relates to a seitan composition that comprises the seitan dry blend and optionally battering agents and/or coating agents. Further, a seitan food product comprising the seitan composition and a process of making the seitan food product are described.

### CROSS REFERENCE TO RELATED APPLICATIONS

This application claims the benefit of European Application No. 23168907.6, filed Apr. 20, 2023, which is hereby incorporated by reference in its entirety.

### FIELD OF INVENTION

This invention relates to the field of meat substitute products, in particular seitan-based food products.

### BACKGROUND

Traditionally, meat products have taken an important place in our diet. Meat products are consumed in many different forms as whole muscle or minced pieces of meat that are cooked, grilled, smoked, cured, or fermented in form of hamburgers, patties, sausages, meat balls, nuggets and many more.

There is a growing consumer trend for reducing or completely removing animal protein from their diets. Consumers switch towards plant-based meat substitutes because of various reasons such as health concerns, environmental concerns, sustainability, or animal welfare. For example, seitan, made from either wheat flour or wheat gluten, is used as a meat substitute high in protein.

In order for a regular meat consumer to be motivated to choose for meat substitutes, it is critical that these substitutes mimic processed meat products in terms of texture and organoleptic properties, like appearance, flavor, bite, succulence, mouthfeel, and overall acceptance.

Some vegan chicken recipes exist on the internet, such as “The Pot Thickens: “How to make QUICK vegan chicken (15 min seitan)””, published on YouTube under the URL: https://www.youtube.com/watch?v=irTsXkAuZHg. However, this recipe is for making chicken-like pieces in a sweet and savory sauce and is not suitable for making vegan/vegetarian/plant-based chicken nugget substitutes.

There is still a need to improve the texture and/or organoleptic properties of meat substitutes, in particular seitan-based products, such as vegan/vegetarian/plant-based chicken nugget substitutes, which are typically made by boiling a wheat gluten dough in a broth. The present invention provides such a solution.

### SUMMARY

The present disclosure provides a seitan dry blend that comprises vital wheat gluten, pea protein (preferably as pea protein isolate), and vegetable bouillon. The ratio of vital wheat gluten to pea protein in the seitan dry blend is from 5:1 to 9:1.

The seitan dry blend of the present invention preferably does not include any flour and in particular preferably does not include any cereal flour and more in particular preferably does not include any wheat flour.

The present disclosure also provides a seitan composition that comprises the seitan dry blend of the present invention and optionally one or more of the following: battering agents and coating agents.

The present disclosure also provides a seitan food product that comprises the seitan composition of the present invention.

The present disclosure also provides a use of a seitan dry blend of the present invention to prepare a seitan food product.

The present disclosure also provides a use of a seitan food composition of the present invention to prepare a seitan food product.

The present disclosure further provides a process for making a seitan food product that comprises the steps of: (a). blending vital wheat gluten, pea protein (preferably pea protein isolate), and vegetable bouillon to form a seitan dry blend; (b). mixing the seitan dry blend with water in a ratio of, seitan dry blend to water, from 1:0.5 to 1:2 to form a seitan dough; (c). boiling the seitan dough with/in water to form a boiled dough or steaming the seitan dough to form a steamed dough; (d). optionally coating the boiled dough or steamed dough with battering agents and coating agents to form the seitan food product; and; (e). optionally cooking the seitan food product. In this process, a step (e), if present, happens any time after the boiling or steaming step of step (c). The process preferably happens in the order of step (a), then step (b), then step (c), then step (d), and finally optional step (e). Instead of immediately cooking the seitan food product in a step (e), the seitan food product can first be stored at fridge or freezer temperatures until the seitan food product is ready to be cooked for consumption.

The seitan dough made using the seitan dry blend of the present invention preferably does not include any flour and in particular preferably does not include any cereal flour and more in particular preferably does not include any wheat flour.

The present invention is as set out in the following clauses:

Clause 1. A seitan dry blend, comprising:
a. vital wheat gluten;
b. pea protein, preferably as pea protein isolate; and
c. vegetable bouillon;
wherein the ratio of vital wheat gluten to pea protein is from 5:1 to 9:1.

Clause 2. The seitan dry blend of clause 1, wherein the ratio of vital wheat gluten to pea protein to vegetable bouillon is from 4:1:1 to 10:1:1.

Clause 3. The seitan dry blend of any of the preceding clauses, comprising, based on the total weight of the seitan dry blend:
a. 65 to 90 wt % vital wheat gluten;
b. 5 to 25 wt % pea protein, preferably as pea protein isolate; and
c. 5 to 25 wt % vegetable bouillon.

Clause 4. The seitan dry blend of any of the preceding clauses, wherein the seitan dry blend does not comprise any flour, preferably any cereal flour, more preferably any wheat flour.

Clause 5. A seitan composition, comprising the seitan dry blend of any of clauses 1 to 4, and optionally one or more of the following:
a. battering agents; and
b. coating agents.

Clause 6. The seitan composition of clause 5, wherein the seitan composition is a seitan dough comprising the seitan dry blend of any of clauses 1 to 4 and water, and the ratio of seitan dry blend to water is from 1:0.5 to 1:2.

Clause 7. The seitan composition of any of clauses 5 to 6 comprising, based on the total weight of the seitan composition:
a. 35 to 60 wt % vital wheat gluten;
b. 1 to 20 wt % pea protein, preferably as pea protein isolate;
c. 1 to 20 wt % vegetable bouillon;
d. 1 to 30 wt % starch;
e. 1 to 10 wt % vegetable stock;
f. 0.5 to 5 wt % flavoring agents; and
g. 1 to 25 wt % coating agents.

Clause 8. A seitan food product comprising the seitan composition of any of clauses 5 to 7.

Clause 9. The seitan food product of clause 8, wherein the seitan food product is a seitan-based nugget, preferably a vegan seitan-based chicken nugget substitute.

Clause 10. Use of the seitan dry blend of any of clauses 1 to 4 to prepare a seitan food product.

Clause 11. Use of the seitan food composition of any of clauses 5 to 7 to prepare a seitan food product.

Clause 12. The use of any of clauses 10 to 11, wherein the seitan food product is a seitan-based nugget, preferably a vegan seitan-based chicken nugget substitute.

Clause 13. A process for making a seitan food product, comprising the steps of:
a. blending vital wheat gluten, pea protein (preferably pea protein isolate), and vegetable bouillon to form a seitan dry blend;
b. mixing the seitan dry blend with water in a ratio of, the seitan dry blend to water, from 1:0.5 to 1:2 to form a seitan dough;
c. boiling the seitan dough with/in water to form a boiled dough or steaming the seitan dough to form a steamed dough;
d. optionally coating the boiled dough or the steamed dough with battering agents and coating agents to form the seitan food product; and
e. optionally further cooking the seitan food product.

Clause 14. The process of clause 13, wherein the seitan dry blend formed in the blending step is selected from any of clauses 1 to 4.

Clause 15. The process of any of clauses 13 to 14, wherein the seitan food product is a seitan-based nugget, preferably a vegan seitan-based chicken nugget substitute, and the process further comprises a step of shaping the seitan dough to form nugget-shaped doughs after the mixing step.

Clause 16. The process of any of clauses 13 to 15, wherein step (e) comprises frying the seitan-based nugget, preferably shallow or deep-frying, or oven-baking the seitan-based nugget.

### DETAILED DESCRIPTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Unless defined otherwise, all technical and scientific terms used herein have the same meaning as commonly understood by one skilled in the art to which this invention belongs. As used herein, each of the following terms has the meaning associated with it as defined below.

Unless expressly stated, ppm (parts per million), percentage, and ratios are on a by weight basis. Percentage on a by weight basis is also referred to as wt % below.

The term “for example,” “for instance,” “such as,” or “including” as used herein is meant to introduce examples that further clarify more general subject matter. Unless otherwise specified, these examples are provided only as an aid for understanding the applications illustrated in the present disclosure and are not meant to be limiting in any fashion.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, “room temperature” or “RT” refer to a temperature between 20° C. and 25° C.

### Seitan Composition

The present disclosure relates to a seitan composition suitable for making a seitan food product. The composition comprises a seitan dry blend and optionally one or more of battering agents and coating agents.

### Seitan Dry Blend

The seitan dry blend of the present invention comprises one or more plant proteins and vegetable bouillon.

Plant proteins may include, but not be limited to, a combination of cereal proteins and legume proteins. The cereal protein is preferably selected from wheat protein. The legume protein is preferably selected from pea protein. Preferably, the combination of plant proteins present in the seitan dry blend are wheat protein and pea protein.

Preferably, the plant proteins present in the seitan composition are in their powder forms.

Wheat protein is also known as vital wheat gluten (VWG) or wheat gluten. By “wheat protein” it is meant herein a vital wheat gluten ingredient. “Wheat protein” and “vital wheat gluten” are used herein as terms interchangeably, but mean the same thing. The protein content of the vital wheat gluten can, preferably, be in a range of 75 to 99 wt %, 80 to 95 wt %, or 85 to 90 wt % on a dry basis. The wheat gluten can be, for example, Gluvital™ 21020 from Cargill.

Pea protein may be derived from sources including, but not be limited to, pea protein isolate and pea protein concentrate. Pea protein is preferably a pea protein isolate or a pea protein concentrate. More preferably the pea protein is a pea protein isolate. The protein content of the pea protein isolate can, preferably, be in a range of 75 to 90 wt %, 75 to 85 wt %, or 80 to 85 wt % on a dry basis. The pea protein can be, for example, Radipure™ S from Cargill, which is a pea protein isolate.

As used herein, “broth” or “stock” refers to a liquid simmered with ingredients such as meat and/or vegetables.

As used herein, “bouillon” refers to a dried or highly dehydrated product, which is available commercially in the form of cube, granule, paste, or powder. Examples may include bouillon products under the brand names of Knorr, Maggi, or Oxo. Preferably, bouillon is a dried or highly dehydrated broth or stock. The bouillon is more preferably a vegetable bouillon, meaning a bouillon made without using any animal derived ingredients or additives.

In one aspect, the (vegetable) bouillon may include, but not be limited to, maltodextrin, salt, yeast extract, flavors, sugar, sunflower oil, onion, spices (e.g., lavas, garlic, turmeric, carrot juice, and the like), and combinations of two or more thereof.

Weight ratio of wheat protein to pea protein (preferably pea protein isolate) in the seitan dry blend can, preferably, be in a range of from 5:1 to 9:1, from 5.5:1 to 8.5:1, from 6:1 to 8:1, or from 6.5:1 to 7.5:1. In one aspect, the ratio of wheat protein to pea protein are present is at least 5:1, or at most 9:1. Preferably, the ratio of wheat protein to pea protein is from 5:1 to 9:1, or more preferably at 7:1.

Weight ratio of wheat protein to pea protein (preferably pea protein isolate) to vegetable bouillon in the seitan dry blend can, preferably, be in a ratio of from 4:1:1 to 10:1:1, from 5:1:1 to 9:1:1, or from 6:1:1 to 8:1:1. In one aspect, the ratio of wheat protein to pea protein to vegetable bouillon is at least 4:1:1, or at most 10:1:1. Preferably, the ratio of wheat protein to pea protein to vegetable bouillon is from 4:1:1 to 10:1:1, or more preferably at 7:1:1.

Weight ratio of wheat protein to vegetable bouillon in the seitan dry blend can, preferably, be in a range of from 5:1 to 9:1, from 5.5:1 to 8.5:1, from 6:1 to 8:1, or from 6.5:1 to 7.5:1. In one aspect, the ratio of wheat protein to vegetable bouillon is at least 5:1, or at most 9:1. Preferably, the ratio of wheat protein to vegetable bouillon is from 5:1 to 9:1, or more preferably at 7:1.

Weight ratio of pea protein (preferably pea protein isolate) to vegetable bouillon in the seitan dry blend can, preferably, be in a range of from 0.1:1 to 2:1, from 0.3:1 to 1.8:1, from 0.5:1 to 1.5:1, or from 0.8:1 to 1.2:1. In one aspect, the ratio of wheat protein to vegetable bouillon is at least 0.1:1, or at most 2:1. Preferably, the ratio of pea protein to vegetable bouillon is from 0.1:1 to 2:1, or more preferably at 1:1.

Weight ratio of plant proteins (including wheat protein and pea protein (preferably pea protein isolate)) to vegetable bouillon in the seitan dry blend can, preferably, be in a range of from 5:1 to 15:1, from 6:1 to 12:1, from 6:1 to 10:1, or from 7:1 to 9:1. In one aspect, the ratio of plant proteins to vegetable bouillon is at least 5:1, or at most 15:1. Preferably, the ratio of plant proteins to vegetable bouillon is from 5:1 to 15:1, or more preferably at 8:1. Preferably, plant proteins are a combination of wheat protein and pea protein.

The seitan dry blend can, preferably, include about 65 wt %, 70 wt %, 75 wt %, 80 wt %, 85 wt %, or 90 wt % wheat protein based on the total weight of the seitan dry blend. In one aspect, wheat protein is present in the seitan dry blend of at least 65 wt %, or at most 90 wt %, based on the total weight of the seitan dry blend. Preferably, wheat protein is present in the seitan dry blend in a range of 65 to 90 wt %, more preferably in a range of 70 to 85 wt %, or even more preferably in a range of 75 to 80 wt %, based on the total weight of the seitan dry blend.

The seitan dry blend can, preferably, include about 5 wt %, 8 wt %, 10 wt %, 15 wt %, 20 wt %, or 25 wt % pea protein (preferably pea protein isolate) based on the total weight of the seitan dry blend. In one aspect, pea protein is present in the seitan dry blend of at least 5 wt %, or at most 25 wt % based on the total weight of the seitan dry blend. Preferably, pea protein is present in the seitan dry blend in a range of from 5 to 25 wt %, more preferably in a range of from 8 to 20 wt %, or even more preferably in a range of from 10 to 15 wt %, based on the total weight of the seitan dry blend.

In one aspect, the seitan dry blend of the present invention can, preferably, include about 5 wt %, 8 wt %, 10 wt %, 15 wt %, 20 wt %, or 25 wt % vegetable bouillon based on the total weight of the seitan dry blend. In one aspect, vegetable bouillon is present in the seitan dry blend of at least 5 wt %, or at most 25 wt %, based on the total weight of the seitan dry blend. Preferably, vegetable bouillon is present in the seitan dry blend in a range of from 5 to 25 wt %, more preferably from 8 to 20 wt %, or even more preferably from 10 to 15 wt % based on the total weight of the seitan dry blend.

In one aspect, the seitan dry blend of the present invention does not include any flour and in particular does not include any cereal flour and more in particular does not include any wheat flour. Flour is the powdery/powdered substance produced by grinding and sifting grains, without including any steps that have as the main objective is the separation of the protein from the starches. Cereal flour is therefore a powdery/powdered substance produced by grinding and sifting cereal grains and wheat flour is a powdery/powdered substance produced by grinding and sifting wheat grains. For the avoidance of doubt, the term “flour” excludes any powdery/powdered substance derived from processing grains that involves a step to separate the proteins from the starches. Notably, the term “flour” excludes any powdery/powdered substance derived from processing grains, wherein the powdery/powdered substance has a protein content of more than 50 wt %. In particular, the term “flour” does not include the product “vital wheat gluten”.

### Process for Preparing a Seitan Dough

The seitan dry blend can be used in preparing a seitan dough. Such preparation process comprises the steps of: (1). blending wheat protein, pea protein (preferably pea protein isolate), and vegetable bouillon to form a seitan dry blend; and (2). mixing the seitan dry blend with water in a ratio of, seitan dry blend to water, from 1:0.5 to 1:2 to form a seitan dough. The seitan dough can be optionally boiled or steamed to form a boiled or steamed seitan dough.

Preferably, the seitan dry blend formed in the blending step is the seitan dry blend of the present invention.

On preparing a final product of seitan-based nugget, the seitan dough obtained from the mixing step can be further shaped to form nugget-shaped doughs.

The seitan dough of the present invention preferably does not include any flour and in particular preferably does not include any cereal flour and more in particular preferably does not include any wheat flour.

### Battering Agents and Coating Agents

The seitan composition can, preferably, include about 10 wt %, 15 wt %, 20 wt %, 30 wt %, 35 wt %, or 40 wt % battering agents based on the total weight of the seitan composition. Preferably, battering agents are present in the composition of at least 10 wt %, or at most 40 wt %, based on the total weight of the seitan composition. Preferably, battering agents are present in the composition in a range of from 10 to 40 wt %, more preferably from 15 to 35 wt %, or even more preferably from 20 to 30 wt % based on the total weight of the seitan composition.

Battering agents of the seitan composition may include starch, vegetable stock, and/or one or more flavoring agents. Starch can be, for example, a modified starch, such as C*BatterCrisp™ (e.g. C*BatterCrisp™ 05548) from Cargill. Preferably, battering agents of the seitan composition do not include any egg and/or dairy ingredients.

Preferably, battering agents can include dry battering agents and wet battering agents.

Dry battering agents can, preferably, include starch in a range of from 1 to 20 wt %, more preferably from 3 to 15 wt %, or even more preferably from 6 to 12 wt % based on the total weight of the seitan composition. Preferably, the dry battering agents are used in a dry state.

Weight ratio of the seitan dry blend to the dry battering agents in the seitan composition can, preferably, be in a range of from 5:1 to 15:1, from 5:1 to 12:1, or from 8:1 to 12:1. In one aspect, the ratio of the seitan dry blend to the dry battering agents is at least 5:1, or at most 15:1. Preferably, the ratio of the seitan dry blend to the dry battering agents is from 5:1 to 15:1, or more preferably at 10:1.

Wet battering agents can preferably include, based on the total weight of the seitan composition,
(a) starch in an amount of from 5 to 25 wt %, preferably from 8 to 20 wt %, or more preferably from 10 to 15 wt %;
(b) vegetable stock in an amount of from 1 to 10 wt %, preferably from 3 to 8 wt %, or more preferably from 4 to 6 wt %; and
(c) flavoring agents in an amount of from 0.5 to 5 wt %, preferably from 1 to 3 wt %, or more preferably from 1.5 to 2.5 wt %.

Flavoring agent can be selected from a group consisting of herbs (e.g., oregano, basil, rosemary, sage, savory, thyme, bay leave, and the like), spices (e.g., pepper, white pepper, black pepper, mustard, cloves, nutmeg, turmeric, ginger, chili pepper, and the like), dried vegetables (e.g., shallots, garlic, onion, and the like), salt, mustard, meat flavors (e.g., chicken flavor, beef flavor, pork flavor, and the like) and combinations of two or more thereof.

Preferably, the wet battering agents are pre-mixed with water and used in a wet state.

Weight ratio of the seitan dry blend to the wet battering agents in the seitan composition can, preferably, be in a range of from 1:1 to 5:1, from 1:1 to 4:1, or from 2:1 to 4:1. In one aspect, the ratio of the seitan dry blend to the wet battering agents is at least 1:1, or at most 5:1. Preferably, the ratio of the seitan dry blend to the wet battering agents is from 1:1 to 5:1, or more preferably at 3:1.

The seitan composition can, preferably, include about 1 wt %, 5 wt %, 10 wt %, 15 wt %, 20 wt %, or 25 wt % coating agents based on the total weight of the seitan composition. Preferably, coating agents are present in the composition of at least 1 wt %, or at most 25 wt %, based on the total weight of the seitan composition. Preferably, coating agents are present in the composition in a range of from 1 to 25 wt %, more preferably from 5 to 20 wt %, or even more preferably from 10 to 15 wt % based on the total weight of the seitan composition.

Coating agents of the seitan composition may include any kind of coating agent known in the art, for instance breadcrumbs, panko (crushed or ground), breakfast cereals, such as cornflakes, and the like. Preferably, coating agents of the seitan composition do not include any egg and/or dairy ingredients.

Coating agents can, preferably, include cornflakes in a range of from 1 to 25 wt %, more preferably from 5 to 20 wt %, or even more preferably from 10 to 15 wt % based on the total weight of the seitan composition.

Weight ratio of the seitan dry blend to the coating agents in the seitan composition can, preferably, be in a range of from 1:1 to 8:1, from 1:1 to 6:1, or from 2:1 to 6:1. In one aspect, the ratio of the seitan dry blend to the coating agents is at least 1:1, or at most 8:1. Preferably, the ratio of the seitan dry blend to the coating agents is from 1:1 to 8:1, or more preferably at 4:1.

### Process for Preparing Seitan-Based Nuggets

Battering agents (both dry and wet battering agents) and coating agents can be combined with the boiled or steamed seitan dough to form seitan food product, for example, seitan-based nuggets. Such preparation process comprises the step of coating the boiled or steamed seitan dough with battering agents and coating agents to form the seitan food product. The seitan-based nuggets can optionally be cooked when ready to be consumed, preferably by frying (this means frying in oil), to form cooked seitan-based nuggets. Preferably the seitan-based nuggets are shallow or deep fried. The seitan-based nugget can also alternatively be oven-baked, e.g. after coating or spraying with an oil, instead of being fried. Such a cooking step happens after the seitan dough has been boiled or steamed.

Preferably, the coating step can include: (i). pre-mixing wet battering agents with water until all the ingredients of the wet battering agents are well dissolved in water; (ii). coating the boiled or steamed seitan dough first with dry battering agents and then with wet bettering agents to form a battered seitan dough; and (iii). coating the battered seitan dough with coating agents to form the seitan-based nuggets.

It has surprisingly been found in the present invention that the combination of wheat protein, pea protein (preferably pea protein isolate), and bouillon build the necessary network of the seitan-based nuggets such that the seitan-based nuggets of the present invention have a great resemblance to the taste, texture, and/or flavor of chicken nuggets. Because of the aforesaid combination of vegetable proteins and bouillon, the seitan-based nuggets of the present invention are free of additives such as texturizers that are typically found in conventional seitan-based nuggets.

### Formulation

A formulation of the seitan composition of the present invention can include wheat protein, pea protein, vegetable bouillon, starch, vegetable stock, flavoring agent(s), and coating agent(s). Table 1 provides such a preferred formulation. Weight percentages of the ingredients are measured based on the total weight of the seitan composition.

TABLE 1

| Ingredient | Concentration (wt %) |
|---|---|
| Wheat protein | 35 to 60 |
| (i.e., vital wheat gluten) | |
| Pea protein | 1 to 20 |
| (preferably pea protein isolate) | |
| Vegetable bouillon | 1 to 20 |
| Starch | 1 to 30 |
| Vegetable stock | 1 to 10 |
| Flavoring agent(s) | 0.5 to 5 |
| Coating agent(s) | 1 to 25 |

In one aspect, the seitan composition of the present invention does not include any flour, in particular it does not include any cereal flour, and more in particular it does not include any wheat flour.

### Seitan Food Product

The seitan composition of the present invention is designed for making a seitan food product.

Food products can be meat substitute products. The food product of the present disclosure is typically designed for consumption after cooking.

Meat substitute products are food or feed compositions that mimic animal processed whole-muscle meat products (e.g., full muscle chicken, fried chicken tender, full muscle turkey, fried turkey tender, and the like), as well as processed restructured meat products (e.g., burgers, patties, sausages, meatballs, nuggets, and the like). Methods of processing for processed meat products may include, but not be limited to, mixing, blending, forming, fermentation, boiling, and smoking.

In one aspect, the meat substitute products produced by the compositions described in this disclosure are seitan food products. Preferably, the seitan food products produced by the compositions described in this disclosure are seitan-based nuggets, in particular seitan-based chicken nuggets. In another aspect, the structure of seitan-based chicken nugget is substantially similar to a meat-based chicken nugget.

Alternatively, the food product of the present disclosure is a pet food. The term “pet food” means any food composition intended to be consumed by a pet. A pet may be any domestic or tamed animal kept for companionship or pleasure. The pet can, preferably, be an avian, bovine, canine, equine, feline, hircine, lupine, murine, ovine, or porcine animal. Preferably, the pet is a dog or a cat.

### Process for Preparing Seitan Food Product

In accordance with the present invention, a process for preparing a seitan food product is provided. The process comprises the steps of: (a). blending wheat protein, pea protein (preferably pea protein isolate), and vegetable bouillon to form a seitan dry blend; (b). mixing the seitan dry blend with water in a ratio of, seitan dry blend to water, from 1:0.5 to 1:2 to form a seitan dough; (c). either boiling the seitan dough with/in water (i.e., e being submersed and/or floating in boiling water) to form a boiled dough or steaming the seitan dough to form a steamed dough; (d). optionally coating the boiled dough with battering agents and coating agents to form the seitan food product; and (e). optionally cooking the seitan food product.

Preferably, the seitan dry blend formed in the blending step is the seitan dry blend of the present invention.

Preferably, the ratio of wheat protein to pea protein in the seitan dry blend is from 5:1 to 9:1.

Preferably, when the seitan food product is a seitan-based nugget, the process further comprises a step of shaping the seitan dough to form the nugget-shaped doughs after the mixing step and before the boiling or steaming step.

By boiling in or with water it is not meant to include herein steaming, for instance in the presence of small quantities of boiling water that are evaporated by the end of the cooking time. The (shaped) dough is preferably boiled submersed and/or floating in the boiling water, preferably for at least 5 min, 6 min, 7 min or at least 8 min. Alternatively, the (shaped) dough is steamed, preferably for at least 5 min, 6 min, 7 min, 8 min or at least 10 min.

The coating step can, preferably, include steps of: (i). coating the boiled or steamed seitan dough with dry battering agents to form a dry-battered seitan dough; (ii). coating the dry-battered seitan dough with wet battering agents to form a wet-battered seitan dough, wherein the wet battering agents are pre-mixed with water until all the ingredients of the wet battering agents are well dissolved in water; and (iii). coating the wet-battered seitan dough with coating agents to form the seitan food product.

The seitan food product obtained from step (d) can then be stored at fridge or freezer temperatures until it is ready to be cooked for consumption.

When a consumer is ready to eat the seitan food product or a food service provider is ready to serve the seitan food product to a consumer, they can then further cook the seitan food product as a step (e), in particular the seitan food product can be fried or oven-baked. Preferably the seitan food product is shallow or deep-fried. In any case, the seitan dough has first been boiled in boiling water or steamed, before any such cooking step as in step (e).

### EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather should be construed to encompass any and all variations which become evident as a result of the teaching provided herein.

### Example 1—Formulation of the Seitan Food Product

Formulation for making seitan food product, preferably seitan-based nugget, is shown in Table 2. The amounts of the ingredients are measured in wt % of the total weight of the formulation.

TABLE 2

| | |
|---|---|
| Ingredient | wt % |

Seitan dry blend

| | |
|---|---|
| Wheat protein | 47.00 |
| (i.e., vital wheat gluten having at least | |
| 75 wt % protein content on a dry basis) | |
| (Cargill) | |
| Pea protein | 7.00 |
| (i.e., pea protein isolate having at least | |
| 80 wt % protein content on a dry basis) | |
| (Cargill) | |
| Vegetable bouillon | 7.00 |
| (Sourced from local supermarket) | |

Dry battering agents

| | |
|---|---|
| Starch, namely C* BatterCrisp ™ 05548 | 6.00 |
| (Cargill) | |

Wet battering agents

| | |
|---|---|
| Starch, namely C* BatterCrisp ™ 05548 | 12.00 |
| (Cargill) | |
| Vegetable stock | 5.00 |
| (Sourced from local supermarket) | |
| Spices, herbs, and flavors | 2.00 |
| (Sourced from local supermarket) | |

Coating agent

| | |
|---|---|
| Cornflakes | 14.00 |
| (Sourced from local supermarket) | |

### Example 2—Process for Making Seitan-Based Nuggets

The following steps were taken to prepare seitan-based nuggets using the formulation shown in Table 2.
(1). Wheat protein (i.e., vital wheat gluten), pea protein (i.e., pea protein isolate), and vegetable bouillon were blended to form a seitan dry blend.
(2). The seitan dry blend was mixed with water in a ratio of, seitan dry blend to water, around 0.85:1 to form a seitan dough.
(3). The seitan dough was shaped to form nugget-shaped doughs.
(4). The nugget-shaped doughs were placed in water and boiled in the water (for 8 min) to form boiled doughs.
(5). Wet battering agents were pre-mixed with water until all the ingredients of the wet battering agents were well dissolved.
(6). The boiled doughs were coated first with dry battering agents and then with wet bettering agents to form battered doughs.
(7). The battered doughs were coated with coating agents to form seitan-based nuggets.
(8). The seitan-based nuggets were deep-fried at 170° C. to form cooked seitan-based nuggets (for 2 min).

### Example 3—Sensory Study

A sensory evaluation was conducted to compare two different recipes (Recipe A and Recipe B) for making seitan-based nuggets. Recipe A represented an example of the seitan dry blend of the present invention described in the present disclosure.

Table 3 shows compositions of these two recipes.

TABLE 3

| Ingredient | Recipe A (g) | Recipe B (g) |
|---|---|---|
| Wheat protein ingredient | 77.0 | 67.3 |
| (i.e., vital wheat gluten having | | |
| at least 75 wt % protein content | | |
| on a dry basis) | | |
| Pea protein ingredient | 11.5 | 13.5 |
| | (whereby the pea | (whereby the pea |
| | protein ingredient is | protein ingredient |
| | a pea protein isolate | is a pea protein |
| | having at least 80 | concentrate having |
| | wt% protein content | about 56 wt % |
| | on a dry basis) | protein content on |
| | | a dry basis) |
| Wheat flour | — | 13.5 |
| Vegetable bouillon | 11.5 | 11.5 |

Ingredients from recipes A and B were respectively coated with dry battering agents, wet battering agents, and coating agents to prepare the seitan-based nuggets using the steps (1) to (6) outlined in Example 2. Compositions of the dry battering agents, the wet battering agents, and the coating agent are the same as described in Example 1. The seitan-based nuggets were then deep-fried at 170° C. to form cooked seitan-based nuggets A1 (made from recipe A) and B1 (made from recipe B) for sensory testing.

Another seitan-based nuggets samples, A2 (from recipe A) and B2 (from recipe B), were prepared different from the steps (1) to (6) of Example 2. In this preparation method, the wheat protein ingredient, the pea protein ingredient, the wheat flour (only in recipe B), the vegetable bouillon (but reduced down to only 2.7 g instead of 11.5 g) and the same spices, herbs, and flavors as used in Example 1 in the wet battering agents were mixed together and warm or lukewarm water (up to one cup) was added to form a seitan dough. The seitan dough was then ripped into nugget-shaped doughs. The nugget-shaped doughs were then cooked in a pan with oil, when the sides were browned, the nugget-shaped doughs were cooked all the way through that took about 10 minutes by turning the heat down to medium low. Then, a little bit of water was added to the pan to let the nugget-shaped doughs steam to form the cooked seitan-based nuggets A2 and B2 for sensory testing.

An informal sensory panel with 5 untrained panelists sampled the cooked seitan-based nuggets A1, A2, B1, and B2 in a blind tasting session. The observations are summarized in Tables 4 and 5. In short, all the panelists preferred the seitan-based nuggets A1 and A2 made from Recipe A to the seitan-based nuggets B1 and B2 made from Recipe B.

TABLE 4

| Attribute | Sample A1 | Sample B1 |
|---|---|---|
| Appearance after | Very elastic; difficult to | Not elastic at all and the |
| kneading | tear a piece from the | seitan dough almost fell apart; |
| | seitan dough | super easy to tear the seitan |
| | | dough apart |
| Appearance after | Firm appearance | Very fragile appearance |
| cooking | | |
| Description | Best texture and | No texture at all |
| | firmness | |
| Overall preference | 100% | 0% |

TABLE 5

| Attribute | Sample A2 | Sample B2 |
|---|---|---|
| Appearance after | Can be easily formed | More fluffy and light; lacking |
| cooking | into nugget shapes | a nugget-look |
| Description | Better texture, although | Very fluffy with no texture at |
| | chewy | all |
| Overall preference | 80% | 20% |

1. A seitan dry blend, comprising:
a. vital wheat gluten;
b. pea protein, preferably as pea protein isolate; and
c. vegetable bouillon;
wherein the ratio of vital wheat gluten to pea protein is from 5:1 to 9:1.

2. The seitan dry blend according to claim 1, wherein the ratio of vital wheat gluten to pea protein to vegetable bouillon is from 4:1:1 to 10:1:1.

3. The seitan dry blend according to claim 1, comprising, based on the total weight of the seitan dry blend:
a. 65 to 90 wt % vital wheat gluten;
b. 5 to 25 wt % pea protein, preferably as pea protein isolate; and
c. 5 to 25 wt % vegetable bouillon.

4. The seitan dry blend according to claim 1, wherein the seitan dry blend does not comprise any flour, preferably any cereal flour, more preferably any wheat flour.

5. A seitan composition, comprising the seitan dry blend according to claim 1, and optionally one or more of the following:
a. battering agents; and
b. coating agents.

6. The seitan composition according to claim 5, wherein the seitan composition is a seitan dough comprising the seitan dry blend according to claim 1 and water, and the ratio of seitan dry blend to water is from 1:0.5 to 1:2.

7. The seitan composition according to claim 5 comprising, based on the total weight of the seitan composition:
a. 35 to 60 wt % vital wheat gluten;
b. 1 to 20 wt % pea protein, preferably as pea protein isolate;
c. 1 to 20 wt % vegetable bouillon;
d. 1 to 30 wt % starch;
e. 1 to 10 wt % vegetable stock;
f. 0.5 to 5 wt % flavoring agents; and
g. 1 to 25 wt % coating agents.

8. A seitan food product comprising the seitan composition according to claim 5.

9. The seitan food product according to claim 8, wherein the seitan food product is a seitan-based nugget, preferably a vegan seitan-based chicken nugget substitute.

10. Use of the seitan dry blend according to claim 1 to prepare a seitan food product.

11. Use of the seitan food composition according to claim 5 to prepare a seitan food product.

12. The use according to claim 11, wherein the seitan food product is a seitan-based nugget, preferably a vegan seitan-based chicken nugget substitute.

13. A process for making a seitan food product, comprising the steps of:
a. blending vital wheat gluten, pea protein (preferably pea protein isolate), and vegetable bouillon to form a seitan dry blend;
b. mixing the seitan dry blend with water in a ratio of, the seitan dry blend to water, from 1:0.5 to 1:2 to form a seitan dough;
c. boiling the seitan dough with/in water to form a boiled dough or steaming the seitan dough to form a steamed dough;
d. optionally coating the boiled dough or the steamed dough with battering agents and coating agents to form the seitan food product; and
e. optionally further cooking the seitan food product.

14. The process according to claim 13, wherein the seitan dry blend formed in the blending step is as defined in claim 1.

15. The process according to claim 13, wherein the seitan food product is a seitan-based nugget, preferably a vegan seitan-based chicken nugget substitute, and the process further comprises a step of shaping the seitan dough to form nugget-shaped doughs after the mixing step.

16. The process according to claim 13, wherein step (e) comprises frying the seitan-based nugget, preferably shallow or deep-frying, or oven-baking the seitan-based nugget.
